(19) United States
(12) Patent Application Publication
(10) Pub. No.: US 2025/0218006 A1
(43) Pub. Date: Jul. 3, 2025

(54) AUTOMATED PRODUCT TRACKING

(71) Applicant: ILLINOIS TOOL WORKS INC., GLENVIEW, IL (US)

(72) Inventors: Deon Thompson, Greenville, SC (US); J. Mark Nunn, Simpsonville, SC (US); Zackary R. Roth, Boiling Springs, SC (US)

(73) Assignee: ILLINOIS TOOL WORKS INC., GLENVIEW, IL (US)

(21) Appl. No.: 18/999,687

(22) Filed: Dec. 23, 2024

Related U.S. Application Data
(60) Provisional application No. 63/616,004, filed on Dec. 29, 2023.

(51) Int. Cl. G06T 7/292; H05B 45/20

(52) U.S. Cl. CPC G06T 7/292; H05B 45/20

(57) ABSTRACT

A conveyor system and method of operation of the conveyor system including a conveyor configured to convey a plurality of products and a camera positioned in association with a segment of the conveyor. A light bar is positioned in association with the segment of the conveyor, the light bar having a plurality of tracking lights. A tracking controller is connected between the camera and the light bar and is configured to illuminate one or more tracking lights in the plurality of tracking lights to demonstrate a position of an improperly placed product of the plurality of products. Additional cameras and light bars may be connected with respect to additional segments of the conveyor to enable real time identification of improperly placed product throughout the conveyor.

### CROSS REFERENCE TO RELATED APPLICATION

This application claims the benefit of U.S. Provisional Application, Ser. No. 63/616,004, filed on 29 Dec. 2023. The co-pending provisional application is hereby incorporated by reference herein in its entirety and is made a part hereof, including but not limited to those portions which specifically appear hereinafter.

### BACKGROUND OF THE INVENTION

### Field of the Invention

This invention relates generally to a system, method, and apparatus for automatically tracking product in a conveyor system.

### Description of Prior Art

Conventional conveyor systems may include one or more lanes for separation and travel of individual conveyed products, such as cartons, bottles, cans, boxes, etc. Occasionally such conveyed products will jam or tip over causing production bottlenecks. Current systems require operators to visually locate and remove downed product. This process is time and labor consuming and causes production delays.

The invention generally relates to a system, method and apparatus for automatically tracking and locating product within a conveyor system.

A preferred embodiment of the subject system allows for more complete product flow information to be obtained in a mass flow situation where more conventional sensors are impractical or impossible to place. The subject system preferably lacks any moving parts resulting in greater longevity and a more tamper-proof system.

An intelligent sensor system is preferably placed relative to a conventional conveyor system to process individual frames of live footage in strategically placed locations to provide real-time informative data such as product density, speed, and downed-product detection. Multiple sensors can communicate among each other in a hive-like manner to provide more complex information along the overall machine. This data is then used in a multitude of applications such as downed product tracking.

The subject system, referred to as HartnessVISION™, offers a tracking feature that will visually mark the location of an incorrectly oriented or downed product and then continually update its position in real-time using the data it collects.

Other objects and advantages will be apparent to those skilled in the art from the following detailed description taken in conjunction with the appended claims and drawings.

### BRIEF DESCRIPTION OF THE DRAWINGS

FIG. 1 shows a schematic of the subject system according to one embodiment;

FIG. 2 shows a schematic of the subject system according to one embodiment; and

FIG. 3 shows a schematic of the subject system according to one embodiment.

### DETAILED DESCRIPTION OF THE INVENTION

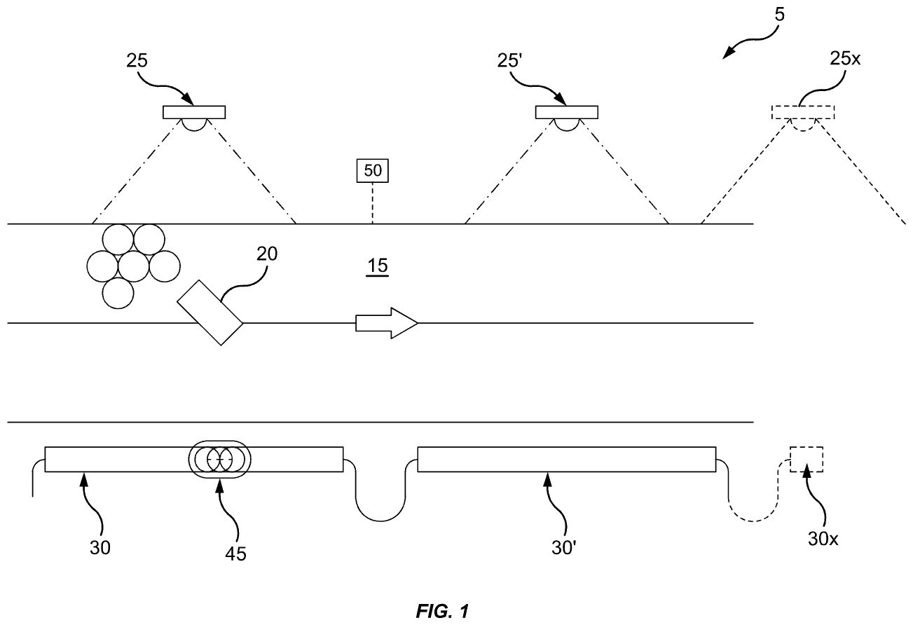

The present invention provides a system, apparatus and method for automatically tracking product within a conveyor system. A conveyor system 5 according to the subject invention is shown in FIGS. 1-3. The subject conveyor system 5 may be used in connection with conventional conveyor systems including rollers, powered belts, skatewheels, chains, flexible conveyors, and others.

FIG. 1 shows a typical illustration of the use of the conveyor system 5. A conveyor 15 moves a plurality of products through the system. Generally speaking, the plurality of products comprise a generally steady stream of parts, boxes, containers, components, etc. in generally any state of pre-production, production, post-production, shipping, and/or supply chain.

One or more cameras 25 are preferably positioned relative to the conveyor 15. A camera as used herein comprises a device for displaying, analyzing, and/or recording visual images in the form of photographs, film, video signals, data, and/or code. Such cameras may comprise a conventional video camera or any other camera suitable for detecting and tracking the data required herein.

One or more light bars 30 are also preferably positioned relative to the conveyor 15. In one embodiment, the light bar 30 comprises a series of configurable tracking lights 45, such as LEDs, arranged in a desired arrangement such as a path generally corresponding with a path of the conveyor 15. In one embodiment, the light bar 30 may comprise a linear arrangement corresponding with a straight section of the conveyor 15.

A first camera 25 of the one or more cameras preferably detects a misoriented product 20 or similar anomaly in the conveyor system 5 and sends a signal to a first light bar 30 to illuminate one or more tracking lights 45 representative of the location of product.

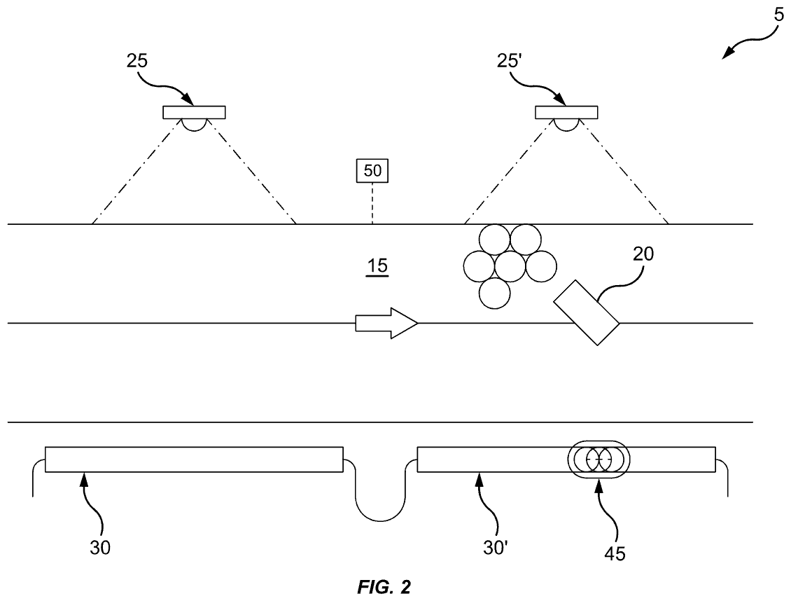

FIG. 2 shows the tracking lights 45 progressing along the first light bar 30 and over to a second light bar 30′ using the measured and/or estimated speed of the misoriented product 20. A second camera 25′ may be positioned to detect the misoriented product 20 and, if it does not, when one is anticipated from a previous camera detection, the system will not proceed to track the product in the second light bar 30′. If the second camera 25′ detects the misoriented product 20, because it has not been corrected, the tracking location of the misoriented product 20 will be updated by the second camera 25′ communication with the second light bar 30′ and the related tracking lights 45.

As the product passes between the first camera 25 and the second camera 25′, the subject system preferably uses an average of the speed between both cameras 25, 25′ to update a tracking location in a dead zone between the detection areas of the cameras.

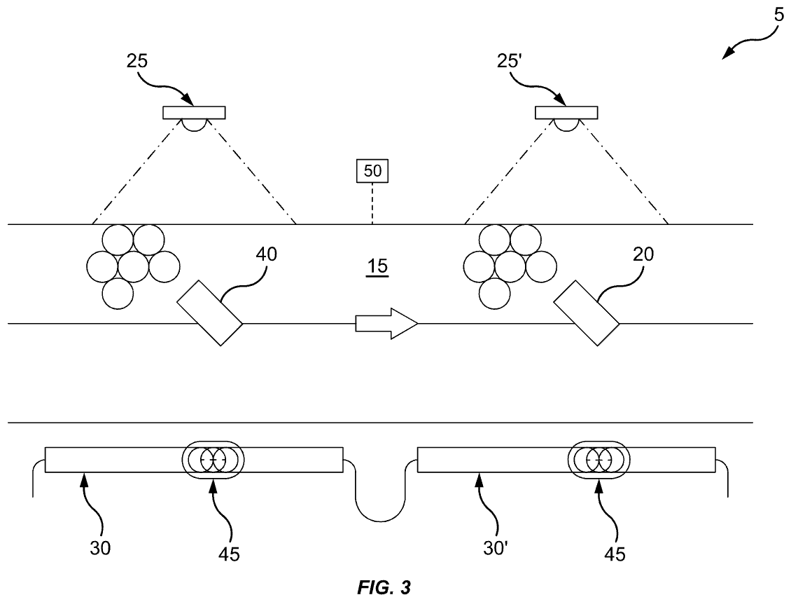

FIG. 3 shows that once the misoriented product 20 has moved a set distance from the first camera 25, if the first camera 25 detects another misoriented product 20, it will send a signal to the light bar 30 to begin illumination of a new series of tracking lights 45′ regardless of the position of the original set of tracking lights 45.

Once the operator has reset the system, the tracking lights 45, 45′ will deactivate and the cameras 25, 25′ will continue analyzing the live footage for more misoriented products restarting the process.

As shown in the figures, the subject conveyor system 5 includes a conveyor 15 configured to convey a plurality of products; a first camera 25 positioned in association with a first segment of the conveyor 15; a first light bar 30 positioned in association with the first segment of the conveyor 15, the first light bar 30 having a plurality of tracking lights 45; a tracking controller 50 connected between the first camera 25 and the first light bar 30 and configured to illuminate one or more tracking lights 45 in the plurality of tracking lights to demonstrate a position of an improperly placed product of the plurality of products.

The tracking controller 50 preferably comprises a standalone or integrated central processing unit that can process data generated among the conveyor 15, the camera 25, and/or the light bar 30.

In additional embodiments, the subject system may include a second camera 25′ positioned in association with a second segment of the conveyor 15; a second light bar 30′ positioned in association with the second segment of the conveyor 15, the second light bar 30′ having a plurality of tracking lights, wherein the tracking controller 50 is connected to the second camera 25′ and the second light bar 30.

In additional embodiments, the subject system may include a plurality of additional cameras 25^{x} positioned in association with corresponding additional segments of the conveyor 15; and a plurality of additional light bars 30^{x} positioned in association with the corresponding additional segments of the conveyor 15, the plurality of light bars 30^{x} each having a plurality of tracking lights, wherein the tracking controller 50 is connected to the additional cameras and the additional light bars.

According to one embodiment, the light bar 30 includes the plurality of tracking lights 45 that are changeable in color. Specifically, one or more tracking lights 45 may be configured to illuminate in a second color from a remainder of the tracking lights, wherein the different color corresponds with the position of the improperly placed product. In additional embodiments, one or more tracking lights are configured to illuminate in a third color from the remainder of the tracking lights to correspond with the position of a second improperly placed product.

A related method of tracking improperly placed products in a conveyor system includes conveying a plurality of products along a conveyor; positioning a first camera in association with a first segment of the conveyor; positioning a first light bar in association with the first segment of the conveyor, the first light bar having a plurality of tracking lights; connecting a tracking controller between the first camera and the first light bar; calculating a position of the improperly placed product; and illuminating one or more tracking lights in the plurality of tracking lights to demonstrate the position of the improperly placed product of the plurality of products.

The invention illustratively disclosed herein suitably may be practiced in the absence of any element, part, step, component, or ingredient which is not specifically disclosed herein.

While in the foregoing detailed description this invention has been described in relation to certain preferred embodiments thereof, and many details have been set forth for purposes of illustration, it will be apparent to those skilled in the art that the invention is susceptible to additional embodiments and that certain of the details described herein can be varied considerably without departing from the basic principles of the invention.

What is claimed is:

1. A conveyor system comprising:
a conveyor configured to convey a plurality of products;
a first camera positioned in association with a first segment of the conveyor;
a first light bar positioned in association with the first segment of the conveyor, the first light bar having a plurality of tracking lights;
a tracking controller connected between the first camera and the first light bar and configured to illuminate one or more tracking lights in the plurality of tracking lights to demonstrate a position of an improperly placed product of the plurality of products.

2. The conveyor system of claim 1 further comprising:
a second camera positioned in association with a second segment of the conveyor;
a second light bar positioned in association with the second segment of the conveyor, the second light bar having a plurality of tracking lights, wherein the tracking controller is connected to the second camera and the second light bar.

3. The conveyor system of claim 2 further comprising:
a plurality of additional cameras positioned in association with corresponding additional segments of the conveyor;
a plurality of additional light bars positioned in association with the corresponding additional segments of the conveyor, the plurality of light bars each having a plurality of tracking lights, wherein the tracking controller is connected to the additional cameras and the additional light bars.

4. The conveyor system of claim 1 wherein the light bar comprises a plurality of LEDs aligned in a linear row.

5. The conveyor system of claim 1 comprising a plurality of additional light bars positioned in association with corresponding additional segments of the conveyor, the plurality of light bars each having a plurality of tracking lights, wherein the tracking controller is connected to the first camera and the additional light bars.

6. The conveyor system of claim 1 wherein the light bar includes the plurality of tracking lights that are changeable in color.

7. The conveyor system of claim 6 wherein one or more tracking lights are configured to illuminate in a second color from a remainder of the tracking lights, wherein the different color corresponds with the position of the improperly placed product.

8. The conveyor system of claim 7 wherein one or more tracking lights are configured to illuminate in a third color from the remainder of the tracking lights to correspond with the position of a second improperly placed product.

9. The conveyor system of claim 2 wherein the tracking controller is configured to calculate an average of speeds between the first segment and the second segment to determine the predicted position of the improperly placed product.

10. The conveyor system of claim 1 wherein the position of the improperly placed product is a predicted position.

11. A method of tracking improperly placed products in a conveyor system, the method comprising:
conveying a plurality of products along a conveyor;
positioning a first camera in association with a first segment of the conveyor;
positioning a first light bar in association with the first segment of the conveyor, the first light bar having a plurality of tracking lights;
connecting a tracking controller between the first camera and the first light bar;
calculating a position of the improperly placed product; and
illuminating one or more tracking lights in the plurality of tracking lights to demonstrate the position of the improperly placed product of the plurality of products.

12. The method of claim 11 further comprising:
positioning a second camera in association with a second segment of the conveyor;
positioning a second light bar in association with the second segment of the conveyor, the second light bar having a plurality of tracking lights;
connecting the tracking controller between the first light bar and the second light bar;
illuminating one or more tracking lights in the plurality of tracking lights to demonstrate the position of the improperly placed product of the plurality of products.
